(19) United States
(12) Patent Application Publication
(10) Pub. No.: US 2025/0149589 A1
(43) Pub. Date: May 8, 2025

(54) WET COATING METHOD FOR MANUFACTURING SOLID-STATE BATTERY CELLS WITH A THERMOPLASTIC ELASTOMER BINDER

(71) Applicant: GM GLOBAL TECHNOLOGY OPERATIONS LLC, Detroit, MI (US)

(72) Inventors: Yong LU, Shanghai (CN); Zhe Li, Shanghai (CN); Qili Su, Shanghai (CN); Haijing LIU, Shanghai (CN)

(21) Appl. No.: 18/677,485

(22) Filed: May 29, 2024

(30) Foreign Application Priority Data
Nov. 3, 2023 (CN) 2023114603465

(51) Int. Cl. H01M 4/62; H01M 4/36; H01M 10/0562

(52) U.S. Cl. CPC H01M 4/623; H01M 4/364; H01M 4/366; H01M 10/0562

(57) ABSTRACT

A battery cell includes A anode electrodes each including an anode active material layer including anode active material and an anode current collector, C cathode electrodes include a cathode active material layer including cathode active material and a cathode current collector, and S separators, where A, C, and S are integers greater than one. At least one of the anode active material layer of the A anode electrodes, the cathode active material layer of the C cathode electrodes, and the S separators includes a thermoplastic binder.

### CROSS-REFERENCE TO RELATED APPLICATIONS

This application claims the benefit of Chinese Patent Application No. 202311460346.5, filed on Nov. 3, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to solid-state battery cells, and more particularly to a wet coating method for manufacturing solid-state battery cells with a thermoplastic elastomer binder.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A battery cell includes A anode electrodes each including an anode active material layer including anode active material and an anode current collector, C cathode electrodes include a cathode active material layer including cathode active material and a cathode current collector, and S separators, where A, C, and S are integers greater than one. At least one of the anode active material layer of the A anode electrodes, the cathode active material layer of the C cathode electrodes, and the S separators includes a thermoplastic binder.

In other features, the cathode active material layer of the C cathode electrodes includes the cathode active material comprising 50 to 98 wt % of the cathode active material layer, and the thermoplastic binder comprising 1 wt % to 20 wt % of the cathode active material layer.

In other features, the cathode active material layer of the C cathode electrodes includes at least one of a solid electrolyte and a conductive additive. The solid electrolyte comprises 1 wt % to 50 wt % of the cathode active material layer. The conductive additive comprises 0.1 wt % to 8 wt % of the cathode active material layer. The thermoplastic binder comprises 1% to 20 wt % of the cathode active material layer.

In other features, the cathode active material is selected from a group consisting of rock salt layered oxides, spinel, polyanion, lithium transition-metal oxides, surface-coated and/or doped cathode materials, and combinations thereof. The thermoplastic binder comprises polystyrene including block copolymers and having a polystyrene ratio in a range from 10% to 70%. The thermoplastic binder is selected from a group consisting of styrene-ethylene-propylene (SEP), styrene-butadiene-styrene (SBS), styrene-ethylene/propylene-styrene (SEPS), ethylene-branched SEPS, ethylene-branched styrene-isoprene-styrene (SIS), styrene-[ethylene-(ethylene-propylene)]-styrene (SEEPS), styrene-ethylene-butylene-styrene (SEBS), ethylene-branched SEEPS, and SEEPS with hydroxyl groups (SEEPS-OH).

In other features, the anode active material layer of the A anode electrodes includes the anode active material comprising 50 to 98 wt % of the anode active material layer, and the thermoplastic binder comprising 1 wt % to 20 wt % of the anode active material layer.

In other features, the anode active material layer of the A anode electrodes includes at least one of a solid electrolyte and a conductive additive. The solid electrolyte comprises 1 wt % to 50 wt % of the anode active material layer. The conductive additive comprises 0.1 wt % to 8 wt % of the anode active material layer. The thermoplastic binder comprises 1% to 20 wt % of the anode active material layer. The anode active material is selected from a group consisting of a silicon-based material, a carbonaceous material, and a metal oxide, and combinations thereof.

In other features, the solid electrolyte is selected from a group consisting of a sulfide-based solid electrolyte, a halide-based solid electrolyte, and a hydride-based solid electrolyte.

In other features, the S separators include a solid electrolyte and a thermoplastic binder.

A method for manufacturing an electrode for a solid-state battery includes mixing a thermoplastic binder, a solvent, and an active material to form a slurry; and coating the slurry onto a current collector and drying the slurry to form an active material layer of an electrode.

In other features, the solvent has a polarity number in a range from 0.1 to 6.5. The active material comprises 50 to 98 wt % of the active material layer, and the thermoplastic binder comprises 1 wt % to 20 wt % of the active material layer. The method includes adding at least one of a solid electrolyte and a conductive additive to the slurry prior to coating.

In other features, the thermoplastic binder is selected from a group consisting of styrene-ethylene-propylene (SEP), styrene-butadiene-styrene (SBS), styrene-ethylene/propylene-styrene (SEPS), ethylene-branched SEPS, ethylene-branched styrene-isoprene-styrene (SIS), styrene-[ethylene-(ethylene-propylene)]-styrene (SEEPS), styrene-ethylene-butylene-styrene (SEBS), ethylene-branched SEEPS, and SEEPS with hydroxyl groups (SEEPS-OH).

A method for manufacturing an electrolyte layer on a substrate includes mixing a thermoplastic binder and a solvent to form a solution; and creating a slurry by adding a solid electrolyte into the solution. The solid electrolyte is selected from a group consisting of a sulfide-based solid electrolyte, a halide-based solid electrolyte, and a hydride-based solid electrolyte. The method includes coating the slurry onto one of a film and an active material layer of an electrode and drying the slurry.

In other features, the solvent has a polarity number in a range from 0.1 to 6.5. The thermoplastic binder comprises 1 wt % to 20 wt % of the electrolyte layer. The solid electrolyte comprises 80 wt % to 99 wt % of the electrolyte layer.

In other features, the thermoplastic binder is selected from a group consisting of styrene-ethylene-propylene (SEP), styrene-butadiene-styrene (SBS), styrene-ethylene/propylene-styrene (SEPS), ethylene-branched SEPS, ethylene-branched styrene-isoprene-styrene (SIS), styrene-[ethylene-(ethylene-propylene)]-styrene (SEEPS), styrene-ethylene-butylene-styrene (SEBS), ethylene-branched SEEPS, and SEEPS with hydroxyl groups (SEEPS-OH).

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a solid-state battery cell including cathode electrodes, anode electrodes, and separators arranged in a battery cell enclosure according to the present disclosure;

FIG. 2 is a more detailed side cross sectional view of an example of the solid-state battery cell including cathode electrodes, anode electrodes, and separators arranged in a battery cell enclosure according to the present disclosure;

FIG. 3 is a flowchart of a method for manufacturing an electrode for a solid-state battery cell that includes a thermoplastic elastomer binder according to the present disclosure;

FIG. 4 is a flowchart of a method for manufacturing an electrolyte film for a solid-state battery cell that includes a thermoplastic elastomer binder according to the present disclosure;

FIG. 5 is a flowchart of a method for manufacturing a composite electrode for a solid-state battery cell that includes a thermoplastic elastomer binder according to the present disclosure; and

FIG. 6 is a graph illustrating an example of capacity retention as a function of cycles for a solid-state battery cell using a thermoplastic elastomer binder according to the present disclosure.

In the drawings, reference numbers may be reused to identify similar and/or identical elements.

### DETAILED DESCRIPTION

While solid-state battery cells according to the present disclosure are shown in the context of electric vehicles, the solid-state battery cells can be used in stationary applications and/or other applications.

There are several different ways to manufacture electrodes and/or separators for battery cells. For example, some battery cells can be manufactured by dry pressing a powder mixture including solid electrolyte (SE) (such as a sulfide-based SE (S-SE)) onto other layers such as an electrode or film. In other examples, a dry fibrillation process is used and includes compressing/shearing a dry powder mixture and using a binder such as PTFE. In other examples, a wet coating process is used and includes mixing an active material, a solid electrolyte, a binder, a conducting filler, and/or a solvent to form a slurry and applying the slurry onto a current collector.

The wet coating process is likely the most promising method for scaling production of battery cells using sulfide-based solid electrolyte (S-SE). When using S—SEs, a low polar solvent that is compatible with the S—SEs is used according to the present disclosure. However, current binders (e.g., polyvinylidene difluoride (PVDF) and styrene butadiene rubber (SBR)) are not soluble in low polar solvents.

The present disclosure relates to a method for manufacturing the SSB using a wet coating process and a thermoplastic elastomer binder. The thermoplastic binder creates a strong bond between active material particles and the surface of the current collector. For example, an NCM-Si battery cell produced using the method described further below has high capacity retention after cycling (e.g., ˜76.12% capacity retention after 500 cycles at 0.5 C, room temperature).

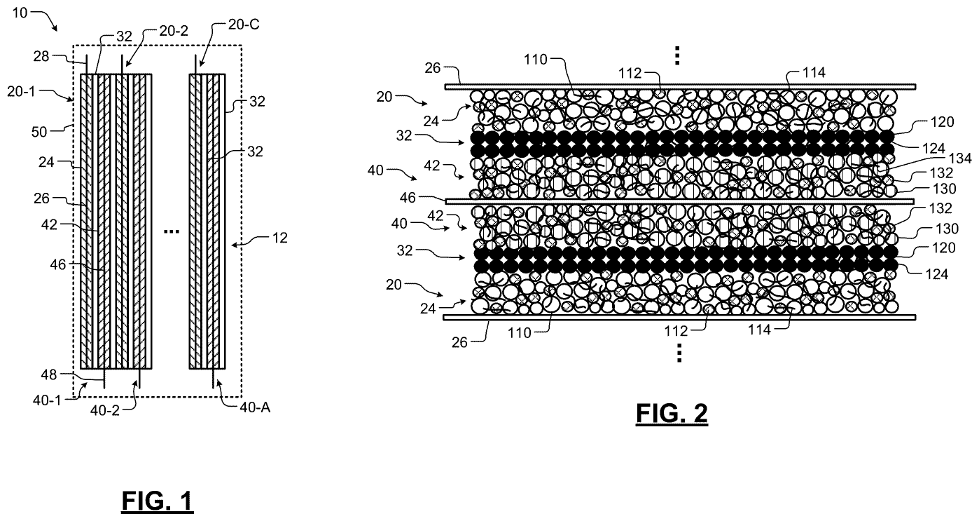

Referring now to FIG. 1, a solid-state battery cell 10 includes C cathode electrodes 20, A anode electrodes 40, and S separators 32 arranged in a predetermined sequence in a battery cell stack 12 located in an enclosure 50, where C, S and A are integers greater than zero. The C cathode electrodes 20-1, 20-2, . . . , and 20-C include cathode active material layers 24 arranged on one or both sides of cathode current collectors 26. The A anode electrodes 40-1, 40-2, . . . , and 40-A include anode active material layers 42 arranged on one or both sides of the anode current collectors 46.

In some examples, the anode active material layers 42 and/or the cathode active material layers 24 are free-standing electrodes that are arranged adjacent to (or attached to) the cathode current collectors 26 and/or the anode current collectors 46, respectively. In some examples, the anode active material layers 42 and/or the cathode active material layers 24 comprise coatings including one or more active materials, one or more conductive fillers/additives, and/or one or more binder materials that are applied to the current collectors.

In some examples, the cathode current collectors 26 and/or the anode current collectors 46 comprise metal foil, metal mesh or expanded metal. In some examples, the cathode current collectors 26 and/or the anode current collectors 46 are made of one or more materials selected from a group consisting of copper, stainless steel, brass, bronze, zinc, aluminum, and/or alloys thereof. External tabs 28 and 48 connected to the current collectors of the cathode electrodes and anode electrodes, respectively, can be arranged on the same or opposite sides of the battery stack 12. The external tabs 28 and 48 are connected to terminals of the battery cells.

Referring now to FIG. 2, an example of the solid-state battery cell is shown. At least one of the anode electrode, the cathode electrode and the separator is manufactured using a thermoplastic binder. The cathode active material layer 24 comprises cathode active material 110, a thermoplastic binder 114 (optional), and a solid electrolyte 112 (optional). The S separators 32 include a solid electrolyte 120 and a thermoplastic binder 124 (optional). The anode active material layer 42 comprises anode active material 130, solid electrolyte 132 (optional), and a thermoplastic binder 134 (optional). While the cathode electrodes 20, the anode electrodes 40, and the separators 32 are shown with the thermoplastic binder, one or more of the cathode electrodes 20, the anode electrodes 40, and/or the separators 32 includes the thermoplastic binder (in any combination).

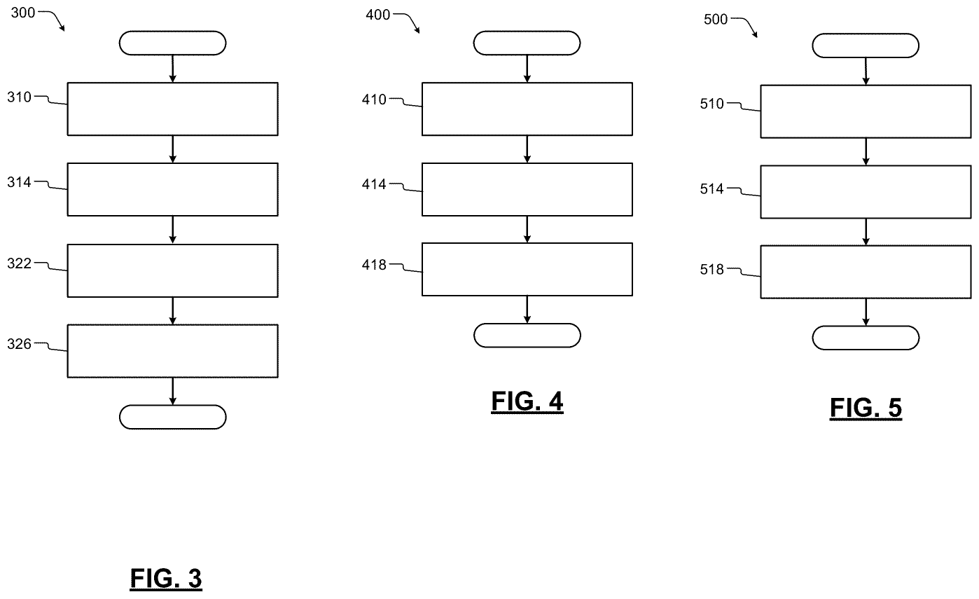

Referring now to FIG. 3, a method 300 for manufacturing an electrode is shown. At 310, a binder and a solvent are mixed to form a solution A. At 314, solid electrolyte and/or a conductive additive are optionally added into the solution A to form a suspension B. At 322, active material is added into the suspension B to form slurry. At 326, the slurry is coated onto surface of current collector and dried to form an active material layer of electrode.

For example, the electrode layer comprises electrode active material, a solid electrolyte, a conductive additive, and a thermoplastic binder. In some examples, the electrode active material comprises 50 wt % to 98 wt % of the active material layer. In some examples, the electrode active material comprises 70 wt % to 98 wt % of the active material layer. In some examples, the solid electrolyte comprises 1 wt % to 50 wt % of the active material layer. In some examples, the solid electrolyte comprises 1 wt % to 30 wt % of the active material layer. In some examples, the conductive additive comprises 0.1 wt % to 8 wt % of the active material layer. In some examples, the thermoplastic binder comprises 1 wt % to 20 wt %. In some examples, the thermoplastic binder comprises 1 wt % to 10 wt % of the active material layer. In some examples, the thermoplastic binder comprises 2 wt % to 5 wt % of the active material layer.

In some examples, the slurry includes a low polar solvent, the solid electrolyte, and the electrode active material (in the same ratios as the electrode layer). In some examples, the solid contents of the slurry are in a range from 20% and 75%. In some examples, the solid contents of the slurry are in a range from 30% and 50%.

In some examples, the low polar solvent has a polarity number in a range from 0.1 to 6.5. The polarity of a solvent is determined by its dielectric constant, which is a measure of its ability to separate positive and negative charges. Solvents with dielectric constants greater than about 5 are considered “polar,” while those with dielectric constants less than 5 are considered “non-polar”. Polar solvents generally dissolve other polar substances because they carry a positive and negative charge, which attracts the opposite charges of the polar substance. When a solid molecule is placed in a polar solvent, it may dissolve if it has polarity of its own. In some examples, the low polar solvents comprise at least one of anisole, para-xylene, tetrahydrofuran (THF), heptane, ethyl propionate, methyl propionate, etc.

For cathode electrodes, the cathode active material is selected from a group consisting of rock salt layered oxides, spinel, polyanion, lithium transition-metal oxides, surface-coated and/or doped cathode materials, and/or low voltage materials. Examples of rock salt layered oxides include LiCoO₂, LiNiₓMn_{y}Co_{1-x-y}O₂, LiNiₓMnyAl_{1-x-y}O₂, LiNiₓMn₁₋ₓO₂, Li₁₊ₓMO₂. Examples of spinel include LiMn₂O₄, LiNi_{0.5}Mn_{1.5}O₄. Examples of polyanion cathodes include (LiV₂(PO₄)₃).

Examples of surface-coated and/or doped cathode materials include LiNbO₃-coated LiMn₂O₄, Li₂ZrO₃ or Li₃PO₄-coated LiNiₓMn_{y}Co_{1-x-y}O₂, and Al-doped LiMn₂O₄. Examples of low voltage materials include lithiated metal oxide/sulfide (e.g., LiTiS₂), Li₂S, and sulfur.

For anode electrodes, the anode active material is selected from a group consisting of a silicon-based material, a carbonaceous material, and a metal oxide. Examples of silicon-based material include Si, SiOₓ, LiSiOₓ, Si/C, SiOₓ/C, and LiSiOₓ/C. Examples of carbonaceous material include graphite, hard carbon, soft carbon, etc. Examples of metal oxides include tin oxide (SnO₂), iron oxide (Fe₃O₄), etc.

In some examples, the thermoplastic binder comprises polystyrene containing block copolymers where polystyrene is in a range from 10% to 70% of the thermoplastic binder. In some examples, the thermoplastic binder comprises polystyrene containing block copolymers where the polystyrene is in a range from 30% to 45% of the thermoplastic binder.

Examples of thermoplastic binders include block copolymers and random block copolymers. Examples of block copolymers include styrene-ethylene-propylene (SEP), styrene-butadiene-styrene (SBS), styrene-ethylene/propylene-styrene (SEPS), ethylene-branched SEPS, and ethylene-branched styrene-isoprene-styrene (SIS). Examples of random block copolymers include styrene-[ethylene-(ethylene-propylene)]-styrene (SEEPS), styrene-ethylene-butylene-styrene (SEBS), ethylene-branched SEEPS, and SEEPS with hydroxyl groups (SEEPS-OH).

In some examples, the solid electrolyte comprises sulfide-based solid electrolyte, halide-based solid electrolyte, hydride-based solid electrolyte, or other solid electrolyte with low grain-boundary resistance.

In some examples, the solid electrolyte is selected from a group consisting of pseudobinary sulfide, pseudoternary sulfide, and pseudoquaternary sulfide. Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, and Li₂S—Al₂S₃ system.

Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X═F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X═F, Cl, Br, I) system, 0.4LiI·0.6Li₄SnS₄ and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35} [Sn_{0.27}Si_{1.08}]P_{1.65}S₁₂.

Examples of halide-based solid electrolyte include Li₃YCl₆, Li₃InCl₆, Li₃YBr₆, LiI, Li₂CdCl₄, Li₂MgCl₄, Li₂CdI₄, Li₂ZnI₄, Li₃OCl. Examples of hydride-based solid electrolyte include LiBH₄, LiBH₄—LiX (X═Cl, Br or I), LiNH₂, Li₂NH, LiBH₄—LiNH₂, Li₃AlH₆.

Referring now to FIG. 4, a method 400 for manufacturing an electrolyte film is shown. At 410, a thermoplastic binder and a solvent are combined to form solution C. At 414, solid electrolyte is added into solution C to form suspension D (corresponding to slurry). At 418, the slurry is coated onto surface of film to form an electrolyte film.

Referring now to FIG. 5, a method 500 for manufacturing an electrolyte film on an electrode is shown. At 510, a thermoplastic binder and a solvent are combined to form a solution E. At 514, solid electrolyte is added into solution E to form a suspension F (corresponding to slurry). At 418, the slurry is coated onto surface of current collector to form a composite electrode.

The solid electrolyte layer comprises solid electrolyte and thermoplastic binder. The solid electrolyte comprises 80 wt % to 100 wt %. In some examples, the solid electrolyte comprises 90 wt % to 100 wt %. In some examples, the thermoplastic binder comprises 1 wt % to 20 wt % if used. In some examples, the thermoplastic binder comprises 1 wt % to 10 wt %. In some examples, the thermoplastic binder comprises 2 wt % to 8 wt %.

In some examples, the electrolyte layer has a thickness in a range from 10 μm to 300 μm. In some examples, the electrolyte layer has a thickness in a range from 10 μm to 50 μm. In some examples, the electrolyte layer has a porosity before being condensed in a range from 3% to 50%. In some examples, the electrolyte layer has a porosity before being condensed in a range from 3% to 20%. In some examples, the slurry has solid content in a range from 20 to 70% (e.g., and solvent in a range from 30% to 75%). In some examples, the slurry has a solid content in a range from 30% to 50% (e.g., and solvent in a range from 50% to 70%).

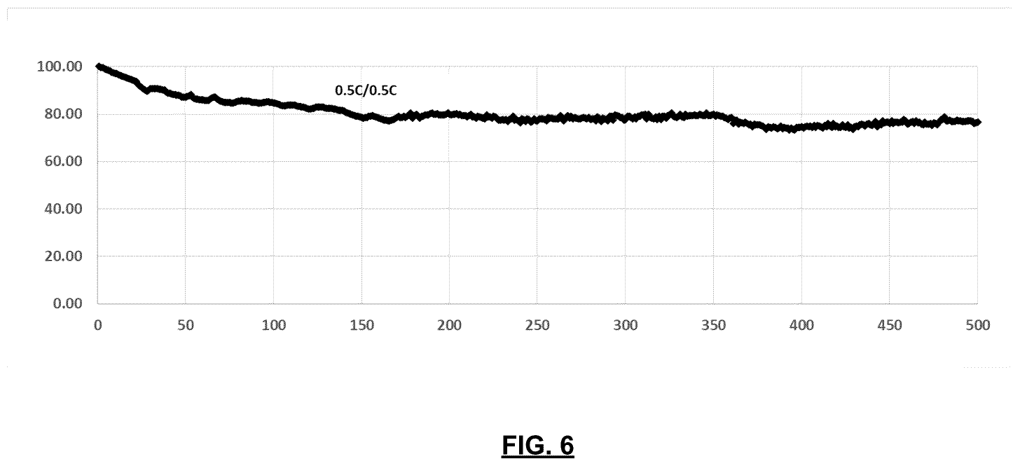

Referring now to FIG. 6, capacity retention is shown as a function of cycles. A battery cell includes a silicon anode with lithium phosphorus sulfide chloride (LPSCl) solid electrolyte and a thermoplastic binder. The cathode electrodes include NMC, LPSCl solid electrolyte, and conductive filler (Super P). The solid electrolyte layer includes LPSCl pellets. The N/P ratio of the battery cell is about 2.5 (where is the capacity ratio between the negative and positive electrode). The thermoplastic binder, the solid electrolyte, and the Si powder were added into a solvent one by one with sufficient mixing and stirring between each step to obtain a mixed slurry. The slurry was coated onto an anode current collector. The thermoplastic binder provides strong bonding between the Si nano particles and between the Si nano particles and the copper foil, which contributes to steady cycling of NCM-Si battery cells. As can be seen, the capacity retention is relatively high over a large number of cycles (e.g., ˜76.12% capacity retention after 500 cycles at 0.5 C, room temperature).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
A anode electrodes each including an anode active material layer including anode active material and an anode current collector;
C cathode electrodes including a cathode active material layer including cathode active material and a cathode current collector; and
S separators, where A, C, and S are integers greater than one,
wherein at least one of the anode active material layer of the A anode electrodes, the cathode active material layer of the C cathode electrodes, and the S separators includes a thermoplastic binder.

2. The battery cell of claim 1, wherein the cathode active material layer of the C cathode electrodes includes:
the cathode active material comprising 50 to 98 wt % of the cathode active material layer, and
the thermoplastic binder comprising 1 wt % to 20 wt % of the cathode active material layer.

3. The battery cell of claim 1, wherein the cathode active material layer of the C cathode electrodes includes at least one of a solid electrolyte and a conductive additive.

4. The battery cell of claim 3, wherein:
the solid electrolyte comprises 1 wt % to 50 wt % of the cathode active material layer,
the conductive additive comprises 0.1 wt % to 8 wt % of the cathode active material layer, and
the thermoplastic binder comprises 1% to 20 wt % of the cathode active material layer.

5. The battery cell of claim 1, wherein the cathode active material is selected from a group consisting of rock salt layered oxides, spinel, polyanion, lithium transition-metal oxides, surface-coated and/or doped cathode materials, and combinations thereof.

6. The battery cell of claim 1, wherein the thermoplastic binder comprises polystyrene including block copolymers and having a polystyrene ratio in a range from 10% to 70%.

7. The battery cell of claim 6, wherein the thermoplastic binder is selected from a group consisting of styrene-ethylene-propylene (SEP), styrene-butadiene-styrene (SBS), styrene-ethylene/propylene-styrene (SEPS), ethylene-branched SEPS, ethylene-branched styrene-isoprene-styrene (SIS), styrene-[ethylene-(ethylene-propylene)]-styrene (SEEPS), styrene-ethylene-butylene-styrene (SEBS), ethylene-branched SEEPS, and SEEPS with hydroxyl groups (SEEPS-OH).

8. The battery cell of claim 1, wherein the anode active material layer of the A anode electrodes includes:
the anode active material comprising 50 to 98 wt % of the anode active material layer, and
the thermoplastic binder comprising 1 wt % to 20 wt % of the anode active material layer.

9. The battery cell of claim 8, wherein the anode active material layer of the A anode electrodes includes at least one of a solid electrolyte and a conductive additive.

10. The battery cell of claim 9, wherein:
the solid electrolyte comprises 1 wt % to 50 wt % of the anode active material layer,
the conductive additive comprises 0.1 wt % to 8 wt % of the anode active material layer, and
the thermoplastic binder comprises 1% to 20 wt % of the anode active material layer.

11. The battery cell of claim 1, wherein the anode active material is selected from a group consisting of a silicon-based material, a carbonaceous material, and a metal oxide, and combinations thereof.

12. The battery cell of claim 9, wherein the solid electrolyte is selected from a group consisting of a sulfide-based solid electrolyte, a halide-based solid electrolyte, and a hydride-based solid electrolyte.

13. The battery cell of claim 9, wherein the S separators include a solid electrolyte and a thermoplastic binder.

14. A method for manufacturing an electrode for a solid-state battery, comprising:
mixing a thermoplastic binder, a solvent, and an active material to form a slurry; and
coating the slurry onto a current collector and drying the slurry to form an active material layer of an electrode.

15. The method of claim 14, wherein:
the solvent has a polarity number in a range from 0.1 to 6.5,
the active material comprises 50 to 98 wt % of the active material layer, and
the thermoplastic binder comprises 1 wt % to 20 wt % of the active material layer.

16. The method of claim 14, wherein further comprising adding at least one of a solid electrolyte and a conductive additive to the slurry prior to coating.

17. The method of claim 14, wherein the thermoplastic binder is selected from a group consisting of styrene-ethylene-propylene (SEP), styrene-butadiene-styrene (SBS), styrene-ethylene/propylene-styrene (SEPS), ethylene-branched SEPS, ethylene-branched styrene-isoprene-styrene (SIS), styrene-[ethylene-(ethylene-propylene)]-styrene (SEEPS), styrene-ethylene-butylene-styrene (SEBS), ethylene-branched SEEPS, and SEEPS with hydroxyl groups (SEEPS-OH).

18. A method for manufacturing an electrolyte layer on a substrate, comprising:
mixing a thermoplastic binder and a solvent to form a solution;
creating a slurry by adding a solid electrolyte into the solution,
wherein the solid electrolyte is selected from a group consisting of a sulfide-based solid electrolyte, a halide-based solid electrolyte, and a hydride-based solid electrolyte; and
coating the slurry onto one of a film and an active material layer of an electrode and drying the slurry.

19. The method of claim 18, wherein:
the solvent has a polarity number in a range from 0.1 to 6.5,
the thermoplastic binder comprises 1 wt % to 20 wt % of the electrolyte layer, and
the solid electrolyte comprises 80 wt % to 99 wt % of the electrolyte layer.

20. The method of claim 18, wherein the thermoplastic binder is selected from a group consisting of styrene-ethylene-propylene (SEP), styrene-butadiene-styrene (SBS), styrene-ethylene/propylene-styrene (SEPS), ethylene-branched SEPS, ethylene-branched styrene-isoprene-styrene (SIS), styrene-[ethylene-(ethylene-propylene)]-styrene (SEEPS), styrene-ethylene-butylene-styrene (SEBS), ethylene-branched SEEPS, and SEEPS with hydroxyl groups (SEEPS-OH).
